(19) United States
(12) Patent Application Publication
(10) Pub. No.: US 2018/0016175 A1
(43) Pub. Date: Jan. 18, 2018

(54) Process of manufacturing non-metallic products

(71) Applicant: Cheng Kuan Wu, Lianyungang City (CN)

(72) Inventor: Cheng Kuan Wu, Lianyungang City (CN)

(21) Appl. No.: 15/715,174

(22) Filed: Sep. 26, 2017

(51) Int. Cl. C03B 19/02

(52) U.S. Cl. CPC C03B 19/02

(57) ABSTRACT

A manufacturing process includes creating 3D shells; connecting the 3D shells together to arrange as rows of the 3D shells and fasten same in a sand box; disposing the sand box in a closed chamber having a furnace and a heater; activating a pump to lower pressure in the closed chamber to be less than the atmospheric pressure; heating the sand box; introducing a molten, non-metallic material from the furnace into each 3D shell; deactivating the pump; flowing gas into the closed chamber to increase the pressure in the closed chamber to be greater than the atmospheric pressure; cooling the sand box; taking the sand box out of the closed chamber; shaking the sand box to separate the rows of the 3D shells from sand; cutting the rows of the 3D shell to obtain the 3D shells; rubbing each 3D shell; and finishing non-metallic products.

### CROSS-REFERENCE TO RELATED APPLICATION

This application is a continuation-in-part (CIP) of U.S. patent application Ser. No. 15/643,498, filed Jul. 7, 2017, which is incorporated herein by reference in its entirety.

### BACKGROUND OF THE INVENTION

### 1. Field of the Invention

The invention relates to manufacturing processes and more particularly to a non-metallic product manufacturing process involving 3D (three-dimensional) printing and other improved characteristics.

### 2. Description of Related Art

A conventional manufacturing process comprising processing circuitry at a server retrieving a source model comprising a shell portion and an internal components portion for a 3D object and defined control points relating to aspects of the shell portion for the 3D object, wherein the shell portion comprises a low resolution exterior surface mesh including a series of interconnected polygons with the control points relating to vertices of the exterior surface mesh and the internal components portion comprises a high resolution mesh; transmitting the low resolution exterior surface mesh of the shell portion and the control points relating to aspects of the shell portion from the server to a user device; displaying a representation model of the received low resolution exterior surface mesh; receiving user specified modifications to the control points; transmitting the modifications the server; processing circuitry at the server receiving the modifications from the user device; processing circuitry at the server applying the received modifications to the source model to create a modified model; processing circuitry at the server subdividing a surface of the modified model to create a high resolution model; processing circuitry at the server modifying the high resolution model wherein modifying the high resolution model by combining with the internal components portion of the source model includes modifying positioning of the internal components portion based on the received modifications to the control points and internal components portion constraint data; and processing circuitry at the server generating print instructions based on the modified high resolution model for manufacture of the 3D object.

While the manufacturing process enjoys its success in the market, continuing improvements in the manufacturing process are constantly being sought.

### SUMMARY OF THE INVENTION

It is therefore one object of the invention to provide a manufacturing process comprising the steps of (a) repeatedly performing the sub-steps of (a1) drawing a design based on specifications of an object, (a2) converting the drawing into a computer file, and (a3) inputting the computer file to a 3D printer to create a 3D shell having a sprue wherein the 3D shell has a thickness of between 0.5 mm and 10 mm until a predetermined number of the 3D shells are created; (b) connecting a plurality of the 3D shells together to arrange as a plurality of rows of the 3D shells; (c) fastening the rows of the 3D shells in a sand box; (d) disposing the sand box in a closed chamber having a furnace and a heater; (e) activating a pump to lower pressure in the closed chamber to a first predetermined pressure less than the atmospheric pressure wherein air in the closed chamber is exhausted to the atmosphere via a three-port valve; (f) activating the heater to heat the sand box to a predetermined temperature; (g) introducing a molten, non-metallic material from the furnace into the sprue of each 3D shell until each 3D shell is filled with the molten, non-metallic material; (h) deactivating the pump; (i) flowing gas into the closed chamber via the three-port valve to increase the pressure in the closed chamber to a second predetermined pressure greater than the atmospheric pressure; (j) gradually cooling the sand box to cure the molten, non-metallic material in each 3D shell in the second predetermined pressure; (k) taking the sand box out of the closed chamber; (I) shaking the sand box to separate the rows of the 3D shells from sand in the sand box; (m) cutting the rows of the 3D shell to obtain a plurality of the 3D shells; (n) rubbing each 3D shell; and (o) removing the sand to finish a plurality of non-metallic products.

The above and other objects, features and advantages of the invention will become apparent from the following detailed description taken with the accompanying drawings.

### BRIEF DESCRIPTION OF THE DRAWINGS

FIG. 1 is a flow chart of a manufacturing process according to the invention; and

FIG. 2 is a continuation of FIG. 1.

### DETAILED DESCRIPTION OF THE INVENTION

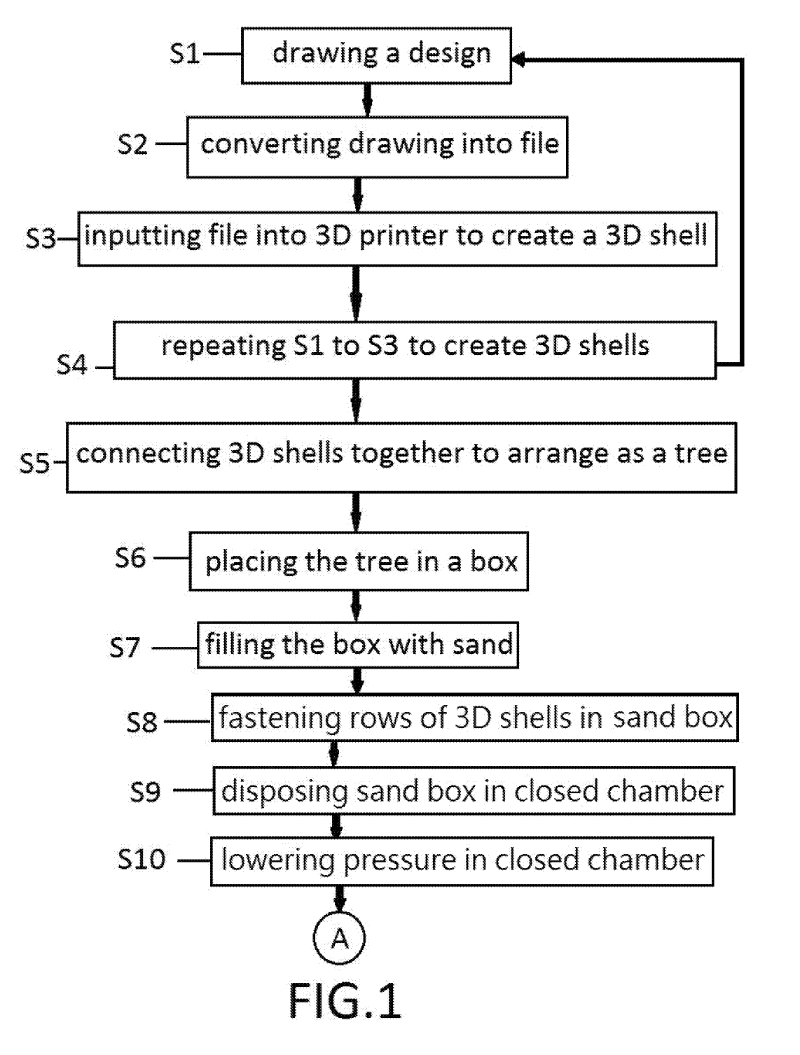

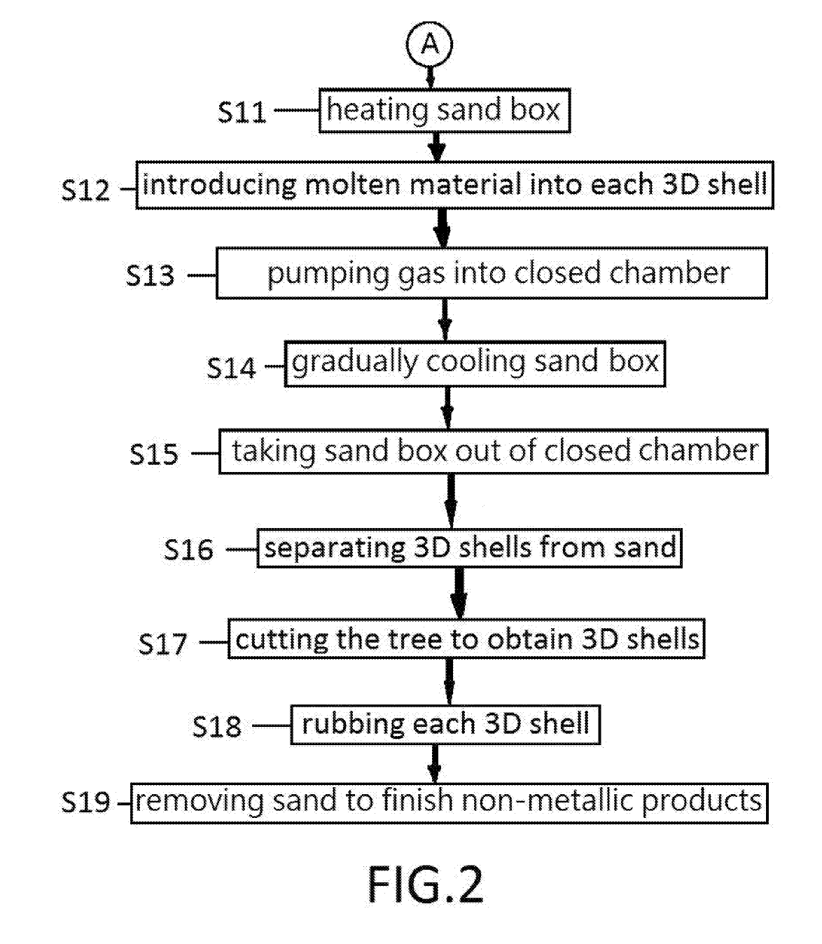

Referring to FIGS. 1 and 2, a flow chart of manufacturing process in accordance with the invention is illustrated. The process comprises the steps of:

Step S1: drawing a design based on specifications of a product.

Step S2: converting the drawing into a computer file.

Step S3: inputting the computer file into a 3D printer to create a 3D shell having a sprue wherein the 3D shell is thin and has a thickness of between 0.5 mm and 10 mm. It makes gas easily penetrate through the 3D shell and facilitates molten material introduction. Further, it necessitates the filling of sand in the box for compaction purposes to be discussed later. The thin 3D shells can save material, decrease the amount of waste, and decrease the manufacturing cost.

Step S4: repeating steps S1 to S3 until a predetermined number of the 3D shells are created.

Step S5: connecting a plurality of the 3D shells together to arrange as a plurality of rows of the 3D shells (i.e., a tree structure) wherein the 3D shells can be of different shapes and/or sizes (i.e., different parts or products to be produced). This makes a single manufacturing process be capable of manufacturing a plurality of different products.

Step S6: placing the rows of the 3D shells in a box.

Step S7: filling the box with at least one kind of sand to fasten the rows of the 3D shells. This can increase a resistance of the rows of the 3D shells in a subsequent molten material introduction step.

Step S8: activating a pump to lower pressure in the sand box and activating a vibration device to shake the rows of the 3D shells in the sand box so that the rows of the 3D shells can be fastened.

Step S9: disposing the sand box in a closed chamber having a furnace and a heater.

Step S10: activating a pump to lower pressure in the closed chamber to a first predetermined pressure less than the atmospheric pressure in which air in the closed chamber is exhausted to the atmosphere via a three-port valve. This is a first characteristic of the invention.

Step S11: activating a heater (e.g., an induction heater) to heat the sand box to a predetermined temperature. This has the benefit of preventing the rows of the 3D shells from being damaged in a next step by decreasing a temperature difference between the rows of the 3D shells in the sand box and a molten material to be introduced from the furnace. This is a second characteristic of the invention.

Step S12: introducing a molten material (e.g., non-metallic material) from the furnace (e.g., an induction furnace) into the sprue of each 3D shell until each 3D shell is filled with the molten material. The introduction is done in the first predetermined pressure less than the atmospheric pressure. This is a third characteristic of the invention.

Step S13: deactivating the pump and flowing gas into the closed chamber via the three-port valve to increase pressure in the closed chamber until an internal pressure of the closed chamber reaches a second predetermined pressure greater than the atmospheric pressure. This is a fourth characteristic of the invention. It is noted that the gas is air in a first preferred embodiment and the gas is an inert gas such as argon in a second preferred embodiment.

Step S14: gradually cooling the sand box to cure the molten material in each 3D shell in the second predetermined pressure. This is a fifth characteristic of the invention. It is noted that steps S10, S11, S12, S13 and S14 can increase uniformity and density of the parts of products to be produced later.

Step S15: taking the sand box out of the closed chamber.

Step S16: shaking the sand box to separate the rows of the 3D shells from the sand.

Step S17: cutting the rows of the 3D shell to obtain a plurality of the 3D shells.

Step S18: rubbing each 3D shell.

Step S19: removing the sand to finish non-metallic parts or products (e.g., lens of a camera).

While the invention has been described in terms of preferred embodiments, those skilled in the art will recognize that the invention can be practiced with modifications within the spirit and scope of the appended claims.

What is claimed is:

1. A manufacturing process comprising the steps of:
(a) repeatedly performing the sub-steps of (a1) drawing a design based on specifications of an object, (a2) converting the drawing into a computer file, and (a3) inputting the computer file to a 3D printer to create a 3D shell having a sprue wherein the 3D shell has a thickness of between 0.5 mm and 10 mm until a predetermined number of the 3D shells are created;
(b) connecting a plurality of the 3D shells together to arrange as a plurality of rows of the 3D shells;
(c) fastening the rows of the 3D shells in a sand box;
(d) disposing the sand box in a closed chamber having a furnace and a heater;
(e) activating a pump to lower pressure in the closed chamber to a first predetermined pressure less than the atmospheric pressure wherein air in the closed chamber is exhausted to the atmosphere via a three-port valve;
(f) activating the heater to heat the sand box to a predetermined temperature;
(g) introducing a molten, non-metallic material from the furnace into the sprue of each 3D shell until each 3D shell is filled with the molten, non-metallic material;
(h) deactivating the pump;
(i) flowing gas into the closed chamber via the three-port valve to increase the pressure in the closed chamber to a second predetermined pressure greater than the atmospheric pressure;
(j) gradually cooling the sand box to cure the molten, non-metallic material in each 3D shell in the second predetermined pressure;
(k) taking the sand box out of the closed chamber;
(I) shaking the sand box to separate the rows of the 3D shells from sand in the sand box;
(m) cutting the rows of the 3D shell to obtain a plurality of the 3D shells;
(n) rubbing each 3D shell; and
(o) removing the sand to finish a plurality of non-metallic products.
